(19) United States
(12) Patent Application Publication
(10) Pub. No.: US 2017/0169515 A1
(43) Pub. Date: Jun. 15, 2017

(54) TRADE 'N PAY INTERFACE

(71) Applicant: Bank of America Corporation, Charlotte, NC (US)

(72) Inventors: Daniel R. Stanton, Sacramento, CA (US); Christopher Hope, Tonbridge Kent (GB); Savit A. Pirl, Bolingbrook, IL (US); Sherin B. Elwy, Boston, MA (US); Daniel M. Whipple, Harrisburg, NC (US); Carolyn L. Thomas, Charlotte, NC (US)

(21) Appl. No.: 14/967,556

(22) Filed: Dec. 14, 2015

(51) Int. Cl. G06Q 40/06

(52) U.S. Cl. CPC G06Q 40/06

(57) ABSTRACT

Apparatus and methods include an interface that mediates between a user's foreign exchange workflow and the user's accounts payable settlement workflow. The interface allows a user to create a foreign currency trade utilizing trading service provided by a trading platform. The interface may then integrate those trades into payment services provided by a treasury platform. The interface may allow the payment services accessible via the treasury platform to create and approve payments based on the trades and proceeds of the trades.

### FIELD OF TECHNOLOGY

Aspects of the invention relate to a software interface for mediating divergent and conflicting workflows of a currency trading platform and a treasury platform.

### BACKGROUND

A financial institution may provide trading and treasury services to users (clients). The financial institution may provide a trading platform for users to access trading services. The financial institution may provide a treasury platform for users to access treasury services.

Trading and treasury services have typically been implemented by two distinct platforms. Treasury services are typically used to manage operating expenses and require available funds to initiate debit-based transactions. Treasury services may include allowing users to move and shift available funds among different locations. For example, the treasury platform may provide users with access to various payment methods, funds and payment destinations.

Trading services typically do not require immediately available funds and users may trade based on credit. Currency trading is one example of a trading service that may be provided to a user on a trading platform. Other illustrative trades may include deliverable forwards, and swaps. Users may trade on margin or credit because, typically, “pre-booking” or scheduling a trade does not require an immediate outlay of funds. In the parlance of currency trading, funds are only due and trade proceeds are only available, on a “value date” of a trade.

Users may access the trading platform to pre-book, book and settle credit-based foreign currency trades. Users may access the treasury platform to initiate and process debit-based payments. The trading platform may be unable to process a partial settlement of a currency trade. The trading platform may be unable to process a partial settlement of a currency trade at different times.

For example, the trading platform may be unable to process a partial settlement of a trade unless all the proceeds of the trade are settled at the same time. The trading platform may only be able to settle all proceeds of a trade on its value date.

Typically, proceeds from a currency trade may not be accessible within the treasury platform. The treasury platform may be configured to process any size debit payments. However, settlements amounts less than the total amount of proceeds from a currency trade may not be initiated from within the treasury platform.

However, users may wish to move funds or pay vendors or otherwise manage operating expenses using proceeds of a trade. For example, the proceeds of a currency trade may be foreign currency obtained at a favorable exchange rate.

Users may wish to settle currency trades using payment methods provided by a treasury platform. For example, the trading platform may only provide access to higher cost fund transfer methods than the funds transfer methods provided by the treasury platform.

It would be desirable to provide users with currency trading services from within a treasury platform. Furthermore, despite fundamental operational differences between trading and treasury platforms, it would be desirable to provide an interface for users to apply treasury services to currency trades and for users to utilize trading services when making debit-based payments.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows illustrative apparatus in accordance with principles of the invention;

FIG. 2 shows illustrative apparatus in accordance with principles of the invention;

FIG. 3 shows illustrative systems in accordance with principles of the invention;

FIG. 4 shows illustrative systems in accordance with principles of the invention;

FIG. 5 shows an illustrative process in accordance with principles of the invention;

FIG. 6 shows an illustrative embodiment of a user interface in accordance with principles of the invention;

FIG. 7 shows another illustrative embodiment of a user interface in accordance with principles of the invention;

FIG. 8 shows another an illustrative embodiment of a user interface in accordance with principles of the invention;

FIG. 9 shows another illustrative embodiment of a user interface in accordance with principles of the invention; and

FIG. 10 shows another illustrative embodiment of a user interface in accordance with principles of the invention.

### DETAILED DESCRIPTION

Apparatus and methods may include providing a user interface that merges and resolves conflicting workflows. The interface may provide access to currency trades pre-booked or booked using a trading platform. The interface may provide the treasury platform access to proceeds of the trades. Using the interface, the trade proceeds may be used by to fund cross-currency payments. The interface's integration of workflows of the trading and treasury platforms may provide access to trading and settlement services through one interface.

Preferably, the interface provides access, from within the treasury platform, to currency trade activity, an ability to initiate payment transactions directly utilizing trade proceeds, an ability to utilize low-value clearing systems to settle trades (e.g., foreign currency trades, deliverable forwards, swaps). In some embodiments, the interface may provide access to payment services accessible via the treasury platform from within the trading platform.

Apparatus and methods for controlling a flow of trading information between a trading platform and a treasury platform are provided. A software interface may perform a computer-implemented method for controlling the flow of trading information. Trading information may include attributes associated with a trade. Illustrative attributes may include buy currency, sell currency, legal entity responsible for the trade, value date and exchange rate.

The interface may provide access to trading services from within the treasury platform. The interface may provide access to treasury services that utilize trades and associated proceeds booked using the trading platform. The interface may provide a new platform for accessing trading and treasury services. The interface may provide a new graphical user interface for user to access trading and treasury services.

Users who wish to utilize trading services provided by the trading platform may access the interface. Accessing the interface may provide users with access to the trading platform and the treasury platform. The interface may schedule (pre-book) or book a foreign currency trade. The trade may convert a first currency into a second currency. The trade may be associated with proceeds of the second currency totaling an amount A.

The interface may receive a first payment request (“request₁”) to schedule a debit-based payment in an amount P₁ of the second currency. The debit-based payment (a treasury service) may be scheduled based on anticipated proceeds of the trade booked using the trading platform. P₁ may be less than A.

The interface may receive settlement instructions from a user. The settlement instructions may be directed to settling a partial amount, such as P₁, of the foreign currency trade. Settlement instructions may utilize payment methods or services provided by the treasury platform.

The treasury platform may provide users with access to lower cost payment methods than payment methods provided by the trading platform. The treasury platform may provide access to a wider variety of payment methods than the trading platform.

In response to receiving settlement instructions associated with P₁, the interface may lock the foreign currency trade. Locking the trade may prevent the trade from being settled by the trading platform or any other platform (e.g., telephone trading platforms) that would otherwise be able to settle the trade. Locking out the other platforms from settling the trade may prevent multiple settlements of a single trade.

The locking may occur for a duration of time. The locking may extend for a period of time when portions of the trade are being settled, or scheduled for settlement, by the interface using treasury services. Other platform that may be locked-out of settling a trade may include Back-Office Settlement Platforms, Trading Platforms or any suitable platforms that may be developed in the future.

The interface may display an amount (A−P₁) of trade proceeds that remain available after scheduling payment P₁. The interface may provide access, using treasury services, to the remaining amount (A−P₁) of the foreign currency trade. The remaining amount (A−P₁) may be allocated to a second payment to a second payee.

The interface may prevent execution of the partial settlement instructions associated with P₁. Even after receiving partial settlement instruction for P₁ or any other amount less than A, the interface may maintain an internal database entry showing that the entire amount A of the foreign currency trade remains unsettled.

Based on the database entry, the trading platform may maintain an internal record that the trade has not even been partially settled. This may resolve a conflict due to the trading platform being unable to process partial settlement payments and the interface enabling the treasury platform to accept partial settlement payments for the trade. However, when a user accesses the trading platform via the interface, the trade will be displayed to a user as have been partially settled.

The interface may receive a plurality of settlement instructions (“SI_{1 . . . n}”) for a foreign currency or other trade. Each SI_{1 . . . n} may be associated with one of settlement payment amounts P_{1 . . . n}. The interface may prevent the treasury platform from executing SI_{1 . . . n} until Σ₁ⁿP=A and funds associated with each settlement amount P_{1 . . . n} have been approved by the treasury platform. When Σ₁ⁿP=A, and each settlement amount P_{1 . . . n} has been approved by the treasury platform, the interface may release SI_{1 . . . n} for execution by the treasury platform.

Approving or verifying a settlement amount may necessitate that the treasury platform be able to access and/or withdraw funds corresponding to the settlement amount from a location specified by the settlement instructions. The location may include a bank account, investment account or other suitable location.

In some embodiments, when Σ₁ⁿP=A, and each settlement amount P_{1 . . . n} has been approved by the treasury system, the interface may utilize the treasury platform to execute the plurality of settlement instructions SI_{1 . . . n} and settle the total trade amount A.

In certain circumstances, each of P_{1 . . . n} may be associated with a distinct method of settlement. The distinct methods of settlement may include: a cross currency automated clearing house (“ACH”) transaction, a draft payment, an account transfer, an international wire transfer and/or any other suitable payment method. In some embodiments, when a partial settlement amount P₁ is associated with a specific method of settlement, the interface may require that each of P_{2 . . . n} also be settled using the specific method of settlement associated with P₁.

In response to the interface receiving a partial settlement instruction, such as SI₁, the interface may be configured to communicate with a plurality of other settlement platforms and lock the foreign currency trade from being settled by any of the plurality of other settlement platforms.

A foreign currency trade may be associated with a value date. The value date is the delivery date of proceeds of the trade. For example, for spot trades, the value date may be the future date on which the trade is settled. For spot foreign exchange trades, the value date is typically two days after the trade is booked.

To integrate currency trades into a treasury platform workflow and allow users to make payments and/or transfers using the proceeds of a trade, the treasury platform (accessed via the interface) may be configured to immediately show, even before value date, the amount of funds that will be available on the value date.

By accessing the treasury platform using the interface, users may access trade proceeds immediately, even before the actual value date. For example, user may schedule payments using anticipated proceeds of the trade. Allowing users to schedule such transactions poses a risk to the financial institution—the user may utilize the trade proceeds for payments and then refuse to settle the trade on value date.

In some embodiments, the interface may allow payments utilizing trade proceed to be scheduled but not allow executing of those payments until the trade is settled. If the trade is not settled on the value date, the interface may push the scheduled payments that utilize the trade proceeds into a repair queue. The interface may prevent of suspend payments in the repair queue from being executed. Once a payment has been pushed into the repair queue, the user may have the option to settle the trade and reinstate the scheduled payment or to cancel the scheduled payment. The interface may also allow the user to settle the trade and alter the scheduled payment. Altering the scheduled payment may include changing a designated payee, an execution date, a payment transfer method or any suitable attribute of the scheduled payment.

If the trade does not settle on its value date, the interface may determine an exchange rate for the trade proceeds on the value date. If the interface determines that the financial institution (which typically has already obtained the trade proceeds in anticipation of settling the trade on its value date) may sell the trade proceeds back to the market at potential cost. After the financial institution unwinds its currency position, the trade is reversed and cannot be settled by either the treasury platform or the trading platform.

If, on the value date, selling the trade proceeds back to the market will result in a loss, the interface may be configured to decide whether to cancel the payment initiated using the treasury platform or roll the value date—taking a risk that the user will settle the trade at the price agreed upon on a later date.

Rolling a trading may include transforming or reclassifying the trade. For example, if a trade was originally booked as spot trade, rolling the trade may include converting the trade into a window forward.

When a trade is past its value date, the interface may unlock the trade. Unlocking the trade preferably allows any one of the plurality of settlement platforms to attach to the trade for settlement.

After unlocking the foreign currency trade, each of the plurality of settlement platforms may settle any portion P_{2 . . . n} of the total amount A (trade proceeds). Any of the plurality of platforms may settle any one of amounts P_{2 . . . n}. If a trade is past its value date, any portion P_{2 . . . n} of the amount A may be settled without being restricted to a settlement method specified in the settlement instructions for P₁ received before the trade went past its value date.

Apparatus and methods may include a software interface that performs a computer-implemented method for controlling access to a foreign currency trade. The interface may control or coordinate access to the trade by mediating between a currency trading platform and by a treasury platform. The trading platform may set a value date for the trade. The treasury platform may register a debit-based payment before the value date based on proceeds of the trade expected to be available on or after the value date. The interface may provide access to the trade from within the treasury platform.

When a user accesses the treasury platform, the interface may provide access to trading services for booking a foreign currency trade. The trade may convert a first currency into an amount A of a second currency (trade proceeds) on a value date.

The interface may provide the treasury platform access to the trade. For example, the treasury platform may display the amount A of the second currency as being available for a debit-based payment. The interface may allow the treasury platform to schedule a first debit-based payment to a first payee using the proceeds of the trade. Scheduling the first debit payment may include attaching to or otherwise reserving the amount A of the second currency expected to be available on the value date. The treasury platform may schedule execution (or release) of the first debit payment on or after the value date associated with the trade. The treasury platform may schedule execution of the first debit payment before the value date associated with the trade.

The treasury platform may not allow execution of the first debit transaction until the value date. The interface may provide the treasury platform access to settle the trade or issue settlement instructions for the trade. The treasury platform may accept settlement or settlement instructions on, before or after the value date.

When the trade is settled on the value date (based on settlement instructions provided on or before the value date), the interface may allow the treasury platform to execute the first debit-based transaction and transfer the amount A to the first payee. When a trade remains unsettled on the value date, the interface may allow the trading platform to assign a new value date to the trade (“roll” the value date). The new value date may be any suitable date.

When a trade remains unsettled on its value date, the interface may de-allocate the amount A from the first debit-based payment and any other debit-based payments scheduled by the treasury platform that utilize proceeds of the trade. De-allocating the first debit-based payment may include severing the trade proceeds from being used as a funding source for a payment. The scheduled payments may be pushed into a repair queue.

Following de-allocation of the trade, the interface may allow the treasury platform to access the trade and schedule a second debit-based payment. The second debit payment may be allocated before or after the new value date is assigned to the trade. The second debit-based payment may allocate amount A (or any amount of the proceeds less than A) of the second currency to a second payee. The second debit-based payment may be scheduled for execution on or after the new value date assigned to the trade. The new value date assigned to the trade may be at least one day before the scheduled execution date of the second debit-based payment.

The interface may allow the treasury platform to schedule a partial settlement of trade proceeds. The partial settlement may be for an amount that is less than amount A. In some embodiments, scheduling a partial settlement may include using the treasury platform to schedule a payment that utilizes the trade proceeds. For example, the interface may allow the user to provide settlement instructions and direct the portion of the trade proceeds associated with the settle instructions to a specific payee using a specific method of funds transfer. When the interface detects that the treasury system has scheduled a partial settlement and/or payment for an amount less than A, the interface may take steps to coordinate settlement of the trade with other platforms that may otherwise have access to settle the trade. Such coordination may include locking the trade from being settled, partially or wholly, by any other platform that otherwise would have had access to the trade.

For example, the treasury platform may enable a user to split a trade into multiple settlements. However, the trading platform or other back-office platforms of the financial institution may not support partial settlements. The interface may be configured to coordinate or mediate access to the trade based on the specific requirement of individual platforms.

Typically, the trading platform does not allow a trade to be partially settled. Thus, a partially settled trade may be viewed as an unsettled trade. Configuring the interface to coordinate or mediate access to the trade may prevent the trading platform, or other platforms that may have access to the trade, from accepting settlement instructions or payments for more than the proceeds or value of the trade. After a platform has been used to schedule a partial settlement or payment, coordinating or mediating access to a trade may include the interface locking the trade from being accessed by any other platform. Coordinating or mediating access to a trade may include the interface ensuring that scheduled settlement instructions or payments are not executed until settlement instructions are received that wholly cover the value of the trade.

For example, the interface may not allow the treasury platform to execute a scheduled settlement payment until all subsequent settlement payments that are applied to the same trade are also approved. The interface may keep count of how much of the trade proceeds have been settled. The count information may be stored in a database associated with the interface. The interface may also provide the treasury platform and/or trading platform access to the count information. For example, the treasury platform may display the count information to a user on a graphical user interface.

Coordinating access to a partially settled trade may include, with respect to platforms other than the treasury platform, characterizing the partially settled trade as being wholly unsettled. The interface may characterize a partially settled trade as being wholly unsettled until settlement instructions are received and verified for the amount A.

Despite characterizing a trade as being wholly unsettled, the interface may lock the trade from being settled (partially and/or fully) by other platforms. The interface may reserve the trade for settlement by the platform that first scheduled a partial settlement instruction (even though the first scheduled partial settlement instruction may not be executed until settlement instructions are received for the entire amount A).

Thus, for a plurality of settlement instructions (“SI_{1 . . . n}”), each SI_{1 . . . n} being associated with a settlement amount SA_{1 . . . n}, the partially settled trade may be characterized as wholly unsettled with respect to the trading platform until: (1) Σ₁ⁿP=A, and (2) funds corresponding to each SI_{1 . . . n} have been verified as being executable by the treasury platform. Funds may be verified as being available when the treasury platform detects that the funds are present within one or more accounts accessible by the treasury platform.

In some embodiments, when a partial settlement amount such as SA₁ is associated with a specific method of settlement, the interface may restrict the treasury platform executing each of SA_{2 . . . n} (subsequently received partial settlement instructions) using the specific method of settlement associated with SA₁.

For example, when settlement of a trade is split into multiple settlements (each settlement amount being less than amount A) the interface may restrict the multiple settlements based on the initial split of the settlement request. More specifically, if a user enters an initial partial settlement instruction (using the treasury platform) requesting a payment that debits an Integrated Partner Bank (“IPB”), the user may be required to continue entering subsequent settlement requests that debit the IPB. If the user initially enters a partial settlement instruction that utilizes a Cross Currency ACH (“CCACH”), the interface may require that other partial settlement instructions utilize CCACH as well. Other illustrative methods of settlement may include utilizing a draft, an account transfer or an international wire transfer.

When a trade remains unsettled on its value date, the interface may instruct the trading platform to roll the trade and assign a new value date to the trade. Rolling a trade may include postponing settlement of the trade until a later date. Rolling the trade may include reclassifying the trade—such as from a spot trade to a window forward trade. How the interface processes a past value trade may be responsive to a credit rating or past trading behavior of a user.

When the trade is past value, the interface may flag the past value date trade such that when the trade is accessed via the trading platform, the trade is shown as being past the value date. When the value date is rolled, the treasury platform may still access the proceeds of the trade and accept debit-based payments that utilize the proceeds.

When a trade remains unsettled on its value date, the interface may instruct the trading platform to send the trade to repair. Repair may include taking steps to force settlements of the trade based on market conditions on the value date.

Apparatus and methods may include a software interface that performs a computer-implemented method for controlling diverging and/or conflicting workflows of a trading platform and a treasury platform. The treasury platform may be unable to access the trade. The trading platform may be unable to process the partial settlement instructions for the trade.

The interface may provide users of the treasury platform with access to book a foreign currency trade on the trading platform. The foreign currency trade may convert a first currency into a second currency based on an exchange rate. The proceeds of the trade may be an amount A of the second currency.

The interface may configure the treasury system to receive a first payment request (“PR₁”). PR₁ may be a debit-based payment that utilizes proceeds of the trade. For example, PR₁ may request a payment in the amount of P₁ to a first payee. The amount P₁ may be allocated from the proceeds of the trade and may be less than the amount A of the second currency.

After scheduling PR₁, the interface may configure the treasury platform to display proceeds of the trade that remain available for additional debit-based transactions. For example, after scheduling PR₁, the treasury platform may show that an amount (A−P₁) of the second currency may remain available for a second payment request (“PR₂”) to a second payee.

The interface may configure the treasury platform to accept a plurality of payment requests (“PR_{2 . . . n}”). Each of PR_{2 . . . n} may correspond to a debit-based payment of one of amounts P_{2 . . . n} to one of a plurality of payees. Each of amounts P_{2 . . . n} may utilize proceeds of the trade. Each of amounts P_{2 . . . n} may be less than A.

The interface may configure the treasury platform to receive a first settlement instruction (“SI₁”) to settle the amount P₁ of the second currency using a first payment method. SI₁ may be a partial settlement instruction because fulfillment of SI₁ will not settle the total amount A of the trade.

After the treasury platform receives or even executes SI₁, when the foreign currency trade is accessed via the trading platform outside of the interface, the trading platform may show that the total amount A of the second currency remains unsettled. The interface may preferably not update the status of the trade within systems associated with the trading platform until the treasury system:

(1) receives a plurality of settlement instructions SI_{2 . . . n}, each of SI_{2 . . . n} associated with a corresponding settlement amount P_{2 . . . n} such that Σ₂ⁿP=(A−P₁); and
(2) the treasury platform verifies that funds corresponding to each of P_{2 . . . n} are accessible from within the treasury platform. In some embodiments, the interface may not update systems associated with the trading platform until the treasury platform executes each of SI_{2 . . . n}. The execution of settlement instructions SI_{2 . . . n} may be known as a settlement call.

In some embodiments, when P₁ is associated with a method of settlement, the interface may require that each of partial settlement amounts P_{2 . . . n} be executed using the method of settlement associated with P₁.

During a time the treasury platform shows the trade as being partially settled and the trading platform shows the trade as being wholly unsettled, the interface may lock the trade from being settled by any system other than the treasury platform. In some embodiments, during the time that the treasury platform shows the trade as being partially settled, the interface may configured the trading platform to show the trade as having received settlement instructions for the entire value of the trade. In such embodiments, the trading platform may classify the entire value of the trade as “settlement in progress.” The interface may be configured to track and monitor how much of the trade value still requires settlement instructions.

For example, the trading platform may show the amount A of the trade as being unsettled after executing one or more of SI_{1 . . . n-1}. In response to the treasury platform receiving SI₁, the interface may lock the trade until settlement instructions SI_{1 . . . n} for the total amount A are received and/or executed by the treasury platform.

One of ordinary skill in the art will appreciate that the steps shown and described herein may be performed in other than the recited order and that one or more steps illustrated may be optional. Apparatus and methods may involve the use of any suitable combination of elements, components, method steps, computer-executable instructions, or computer-readable data structures disclosed herein.

Illustrative embodiments of apparatus and methods in accordance with the principles of the invention will now be described with reference to the accompanying drawings, which form a part hereof. It is to be understood that other embodiments may be utilized and that structural, functional and procedural modifications may be made without departing from the scope and spirit of the present invention.

As will be appreciated by one of skill in the art, the invention described herein may be embodied in whole or in part as a method, a data processing system, or a computer program product. Accordingly, the invention may take the form of an entirely hardware embodiment, an entirely software embodiment or an embodiment combining software, hardware and any other suitable approach or apparatus. Apparatus and methods may involve the use of any combination of elements, components, method steps, computer-executable instructions, or computer-readable data structures disclosed herein.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

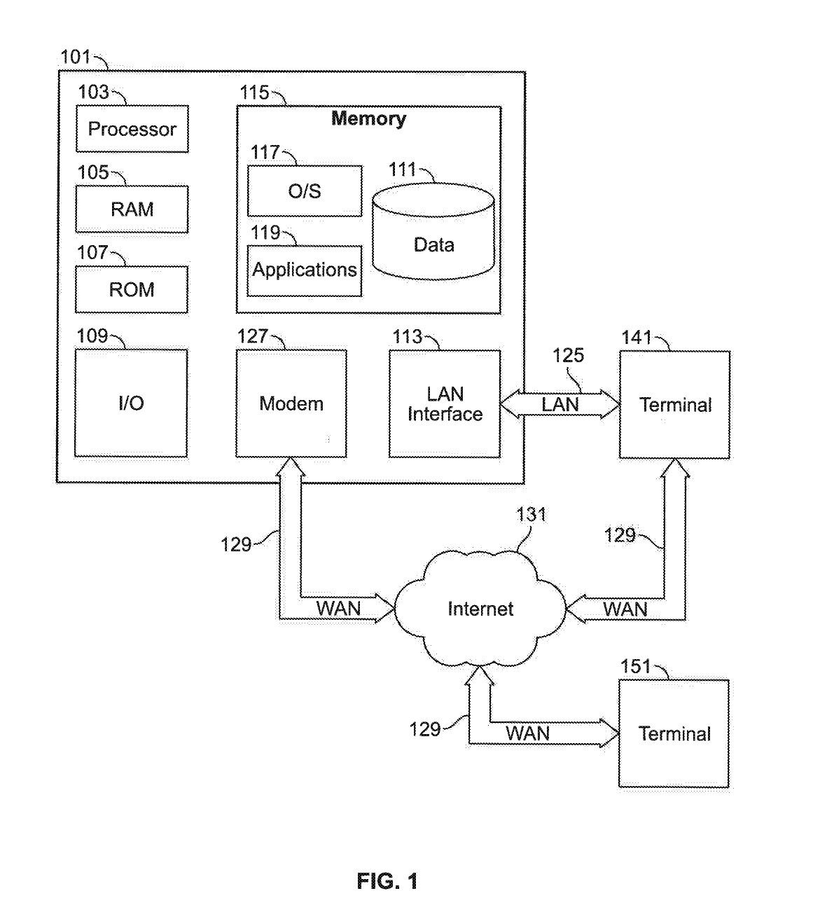

FIG. 1 is a block diagram that illustrates a computing device 101 (alternatively referred to herein as a “server or computer”) that may be used according to an illustrative embodiment of the invention. The computer server 101 may have a processor 103 for controlling overall operation of the server and its associated components, including RAM 105, ROM 107, input/output (“I/O”) module 109, and memory 115.

I/O module 109 may include a microphone, keypad, touch screen and/or stylus through which a user of device 101 may provide input, and may also include one or more of a speaker for providing audio output and a video display device for providing textual, audiovisual and/or graphical output. Software may be stored within memory 115 and/or other storage (not shown) to provide instructions to processor 103 for enabling server 101 to perform various functions. For example, memory 115 may store software used by server 101, such as an operating system 117, application programs 119, and an associated database 111. Alternatively, some or all of computer executable instructions of server 101 may be embodied in hardware or firmware (not shown).

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 113. When used in a WAN networking environment, server 101 may include a modem 127 or other means for establishing communications over WAN 129, such as Internet 131.

It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown). Terminal 151 and/or terminal 141 may be portable devices such as a laptop, tablet, smartphone or any other suitable device for receiving, storing, transmitting and/or displaying relevant information.

Any information described above in connection with database 111, and any other suitable information, may be stored in memory 115. One or more of applications 119 may include one or more algorithms that may be used to implement services provided by the interface, trading platform, treasury platform and/or any other suitable tasks.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

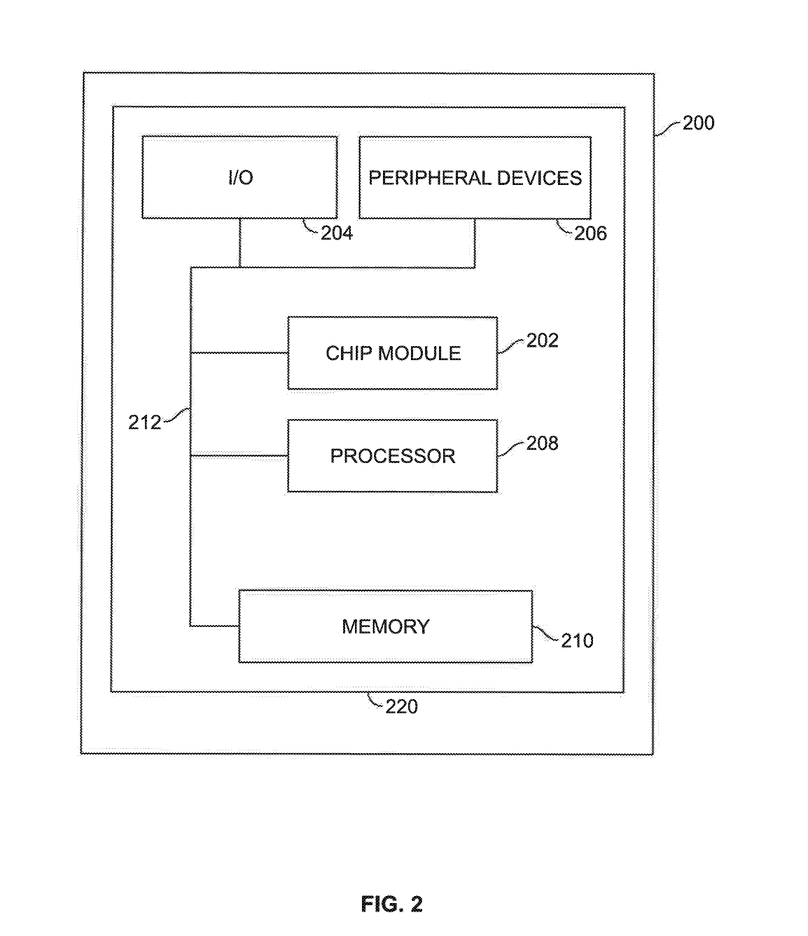

FIG. 2 shows an illustrative apparatus 200 that may be configured in accordance with the principles of the invention. Apparatus 200 may be a computing machine. Apparatus 200 may include one or more features of the apparatus shown in FIG. 1. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable encoded media or devices; peripheral devices 206, which may include counter timers, real-time timers, power-on reset generators or any other suitable peripheral devices; logical processing device 208, which may compute data structural information, structural parameters of the data, quantify indices; and machine-readable memory 210.

Machine-readable memory 210 may be configured to store in machine-readable data structures: trading information, settlement instructions, payment instructions, computer code and any other suitable information or data structures.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

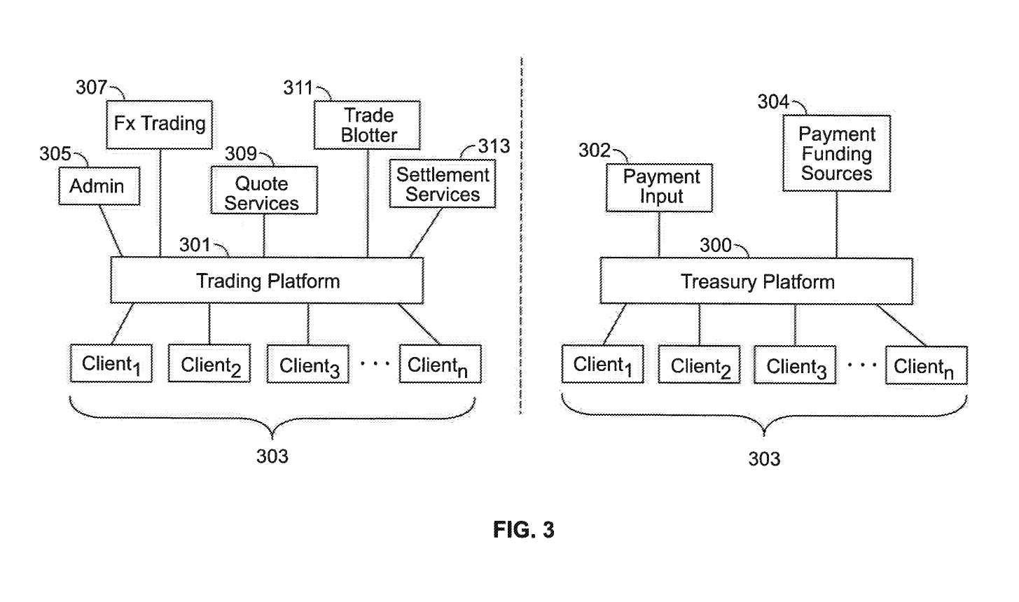

FIG. 3 shows illustrative trading platform 301. Trading platform 301 may be accessed by multiple users (or clients) 303. Users 303 may access various services via trading platform 301.

Users 303 may access admin services 305. Exemplary admin services may provide setting for which users may access trading platform 301, trading limits (e.g. dollar amounts) for authorized users and what type of trades authorized users may schedule using trading platform 301.

Users 303 may access FX trading services 307. Exemplary FX trading services 307 may include scheduling executing and/or settling spot, forward, swap and non-deliverable forward transactions in more than 140 currencies. Exemplary FX trading services 307 may include accepting a file listing multiple trades or accepting input of multiple trades onto one screen to simplify the trade input process.

Exemplary quote services 309 may include obtaining, presenting and allowing users to accept a real-time exchange rate. Exemplary trade blotter services 311 may provide an overview of all of a user's transactions. Exemplary settlement services 313 may include creating settlement templates for repetitive transactions, and a net settling of trades across multiple currency pairs.

FIG. 3 also shows illustrative treasury platform 300. Treasury platform 300 may be access by the users (or clients) 303. Users 303 may access various services via treasury platform 300.

Exemplary payment input services 302 may include providing access to various payment types such as cross-currency wires, low-value clearing system payment, multi-currency drafts multi-banks, internal book transfers, international payroll, regulatory tax payments and bank drafts.

Exemplary payment funding sources 304 accessible to treasury platform 300 may include domestic domiciled accounts and/or foreign domiciled accounts in all global regions and non-host currency accounts.

Typically, users 303 cannot access trading platform 301 via treasury platform 300. Typically, users 303 cannot access treasury platform 300 via trading platform 301. For example, users 303 may not be able to utilize proceeds of a trade booked using FX services 307 as a funding source available in payment funding services 304.

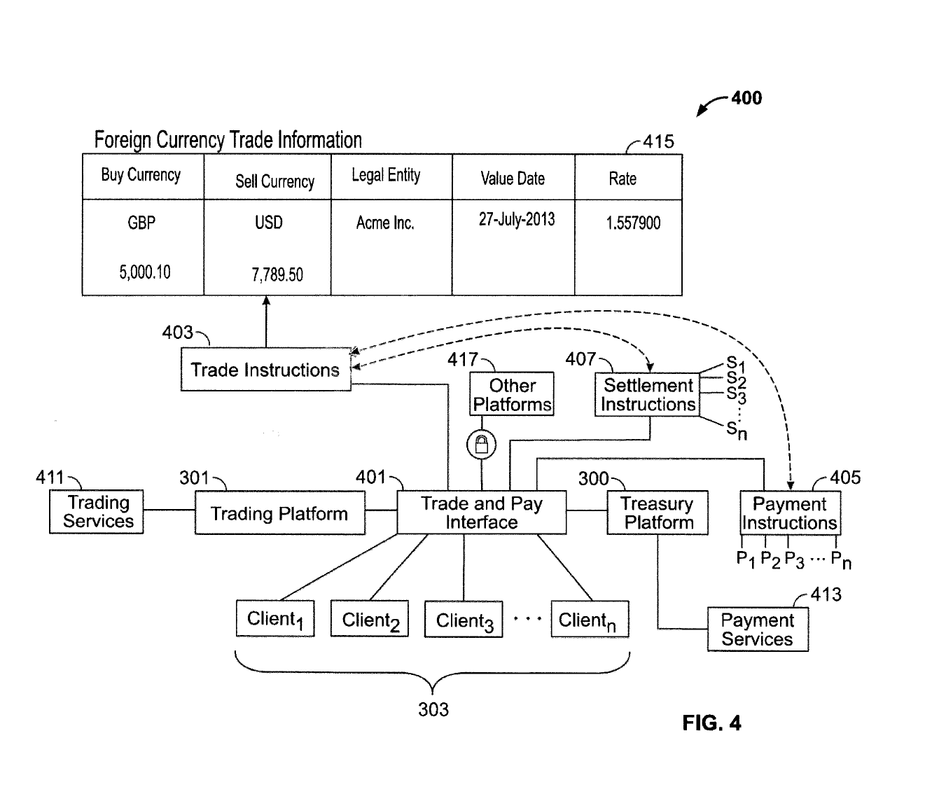

FIG. 4 shows illustrative system 400. System 400 includes Trade and Pay Interface 401. Users 303 may access treasury platform 300 and payment services 413 via Interface 401. Payment services 413 may include any suitable services provided by treasury platform 300, such as exemplary services 302 and 304 (shown in FIG. 3). Users 303 may access trading platform 301 and trading services 411 via Interface 401. Trading services 411 may include any suitable services such as exemplary trading services 305, 307,309, 311, and 313 (shown in FIG. 3).

Interface 401 may control and/or coordinate information flow between trading platform 301 and treasury platform 300. For example, Interface 401 may provide users 303 with the functionality to enter trading instructions 403. Trading instructions may include one or more trade attributes 415. Trading instructions 403 may utilize one or more services provided by trading platform 301 (exemplary services are shown in FIG. 3). Interface 401 may provide users 303 with the functionality to enter settlement instructions 407 and/or payment instructions 405 for trades associated with trading instructions 403. Settlement instructions 407 may utilize one or more services provided by treasury platform 300 (exemplary services are shown in FIG. 3).

For example, via Interface 401, users 303 may access eligible currency trades and payments from a single platform. Such functionality may allow users 303 to use pre-booked trades to fund international payments.

As a further example, Interface 401 may integrate the trade blotter services 311 within payment funding services 304. Such functionality may allow users 303 to create payment templates for recurring payments using proceeds from trades booked or pre-booked on trading platform 301. Using Interface 401, users 303 may search for a trade (e.g., accessing trade blotter services 311) while building a payment on a payment entry screen (e.g., accessing payment funding services 304).

As a further example, if using Interface 401 users 303 initiate a payment using proceeds of a trade, and the amount of the trade proceeds exceeds the payment amount, the users may be able to split the trade across multiple payments. Trade blotter services 411 may be utilized to show users 303 how much trade proceeds are left for funding payments.

As a further example, using Interface 401, users 303 may create payment templates for recurring payments or choose from a list of free-form payments by account (e.g., accessing payment input services 302) when issuing settlement instructions for a trade (e.g., accessing settlement services 313).

Interface 401 may be configured to navigate conflicts and/or differences between how services are provided by trading platform 301 and how services are provided by treasury platform 300.

For example, Interface 401 may mediate workflow conflicts that arise when a user submits settlement instructions using treasury services and is not able to successfully settle a trade using Interface 401. A trade may not successfully settle because the trade has been amended or cancelled by a user.

To mediate such a conflict, Interface 401 may lock a trade, thereby preventing other platforms 417 from settling the trade. The lock may include preventing services provided by trading platform 301 from accessing or modifying the trade. In some embodiments, a locked trade may remain accessible to other platforms if accessed via the treasury platform and associated payment services.

As a further example, Interface 401 may support the ability for a user to split a trade into multiple settlements using services provided by treasury platform 300. However, trading platform 301 may not support partial settlements. Thus, Interface 401 may solve this conflict by preventing treasury platform 300 (and associated services) from releasing a settlement payment until all subsequent payments that are applied to the same trade are also approved. This may require Interface 401 to keep count of how much of trade proceeds have been settled. Interface 401 may store the count information in a database and display it to the user.

As a further example, Interface 401 may allow a user to split proceeds of a trade among multiple payments (utilizing one or more of payment services 413). However, each payment may be associated with a different workflows or financial repercussions (e.g., accounting or tax effects). To integrate the workflows, Interface 401 may restrict entry of split settlements based on the initial settlement request entered. If a user enters a first payment that partially utilizes a trade and a specific payment method or medium, the user will be required to use the same specific payment method or medium for subsequent payment requests that partially utilize the trade.

Interface 401 may be configured to avoid potential conflicts by using a single reference identifier for end to end payment reconciliation and processing. A trade may be assigned a different identifier depending on which platform booked the trade. Trading platform 301 may assign an identifier to trades when providing one or more of trading services 411. However, trades scheduled using telephone platforms may not be assigned an electronic identifier usable by trading services 411 and/or payment services 413. Interface 401 may assign an electronic identifier to trades that are otherwise missing an identifier so that those trades may be accessed by trading services 411 and/or payment services 413. The electronic identifier assigned by Interface 401 may serve as a reconciliation parameter for phone trades, but not for trades scheduled using the trading platform.

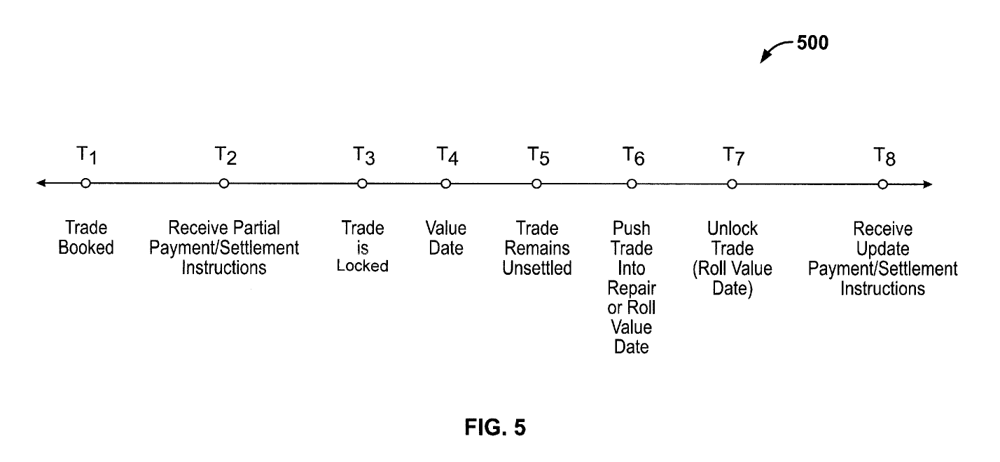

FIG. 5 shows illustrative timeline 500. At T1, a trade may be booked using Interface 401. At T2, Interface 401 may receive partial settlement instructions and/or payment instructions that utilize less than all of the trade proceeds. At T3, in response to receiving the partial settlement/payment instructions, Interface 401 may lock the trade from being settled by other platforms (e.g., by telephone platforms).

T4 may be the value date associated with the trade. At T5, timeline 500 shows that the trade has not been fully settled. At T6, Interface 401 may utilize one or more of trading services 411 and push the trade into repair. Repair may include pushing a payment into the treasury platform's repair queue. The repair queue may hold payments scheduled utilizing a now past value trade, or a trade that now cannot be settled due to being cancelled or amended during the settlement call. Within the repair queue, the user may amend the payment details to be associated with a different trade (that is not yet past value) or book a new live trade and associate the newly booked trade with the previously scheduled payments.

After pushing the trade into repair or rolling the value date, at T7, the Interface unlocks the trade. Unlocking the trade may allow the trade to be settled by any suitable platform. At T8, in response to unlocking the trade, Interface 401 may accept updated settlement/payment instructions from any suitable platform.

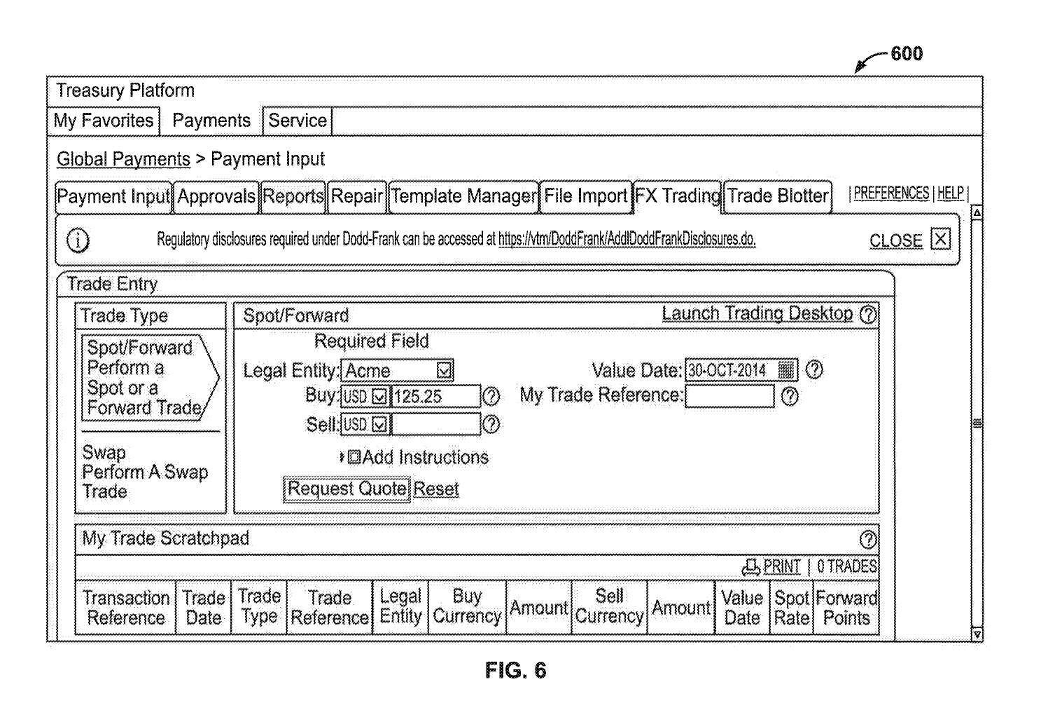

FIG. 6 shows illustrative information 600. Information 600 shows that from within a treasury platform, Interface 401 may provide a user access to trade entry services.

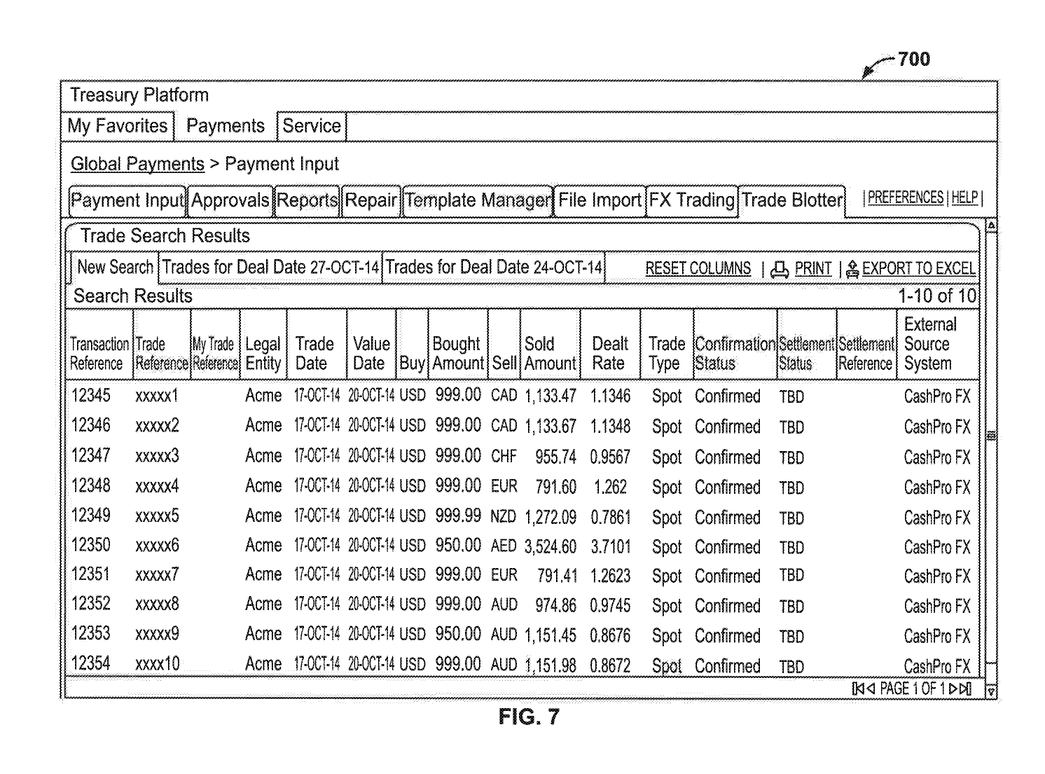

FIG. 7 shows illustrative information 700. Information 700 shows that from within a treasury platform, Interface 401 may provide a user access to trade blotter services.

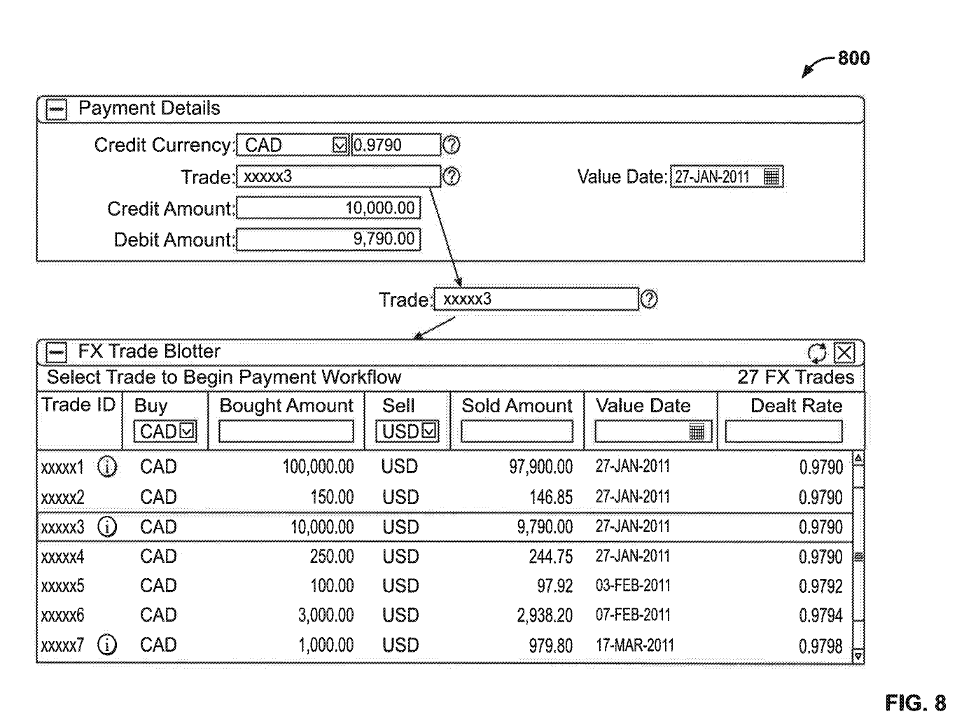

FIG. 8 shows illustrative information 800. Information 800 shows that from within a treasury platform, Interface 401 may provide a user access to payment entry services. Information 800 also shows that providing payment entry services may include providing access to trade blotter services. Trade blotter services may be used to locate a funding source (e.g., a foreign currency trade) for payment entry services.

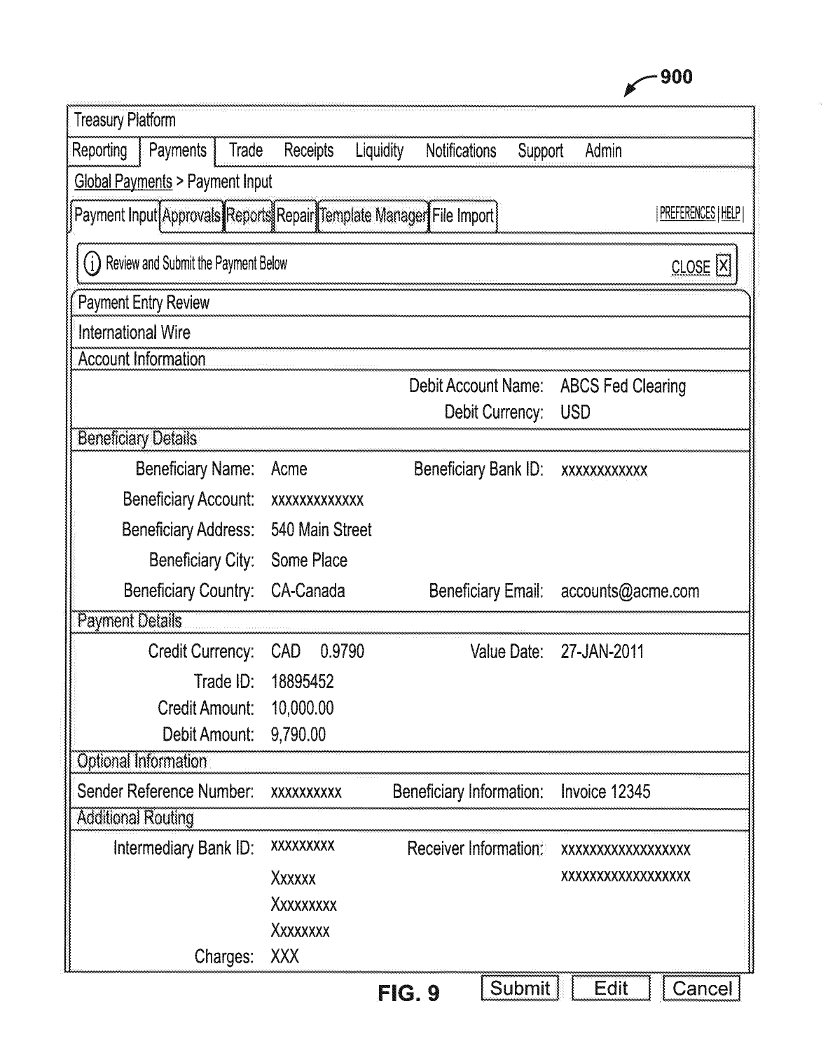

FIG. 9 shows illustrative information 900. Information 900 shows how trade blotter services may be utilized within payment entry services provided by treasury platform 300.

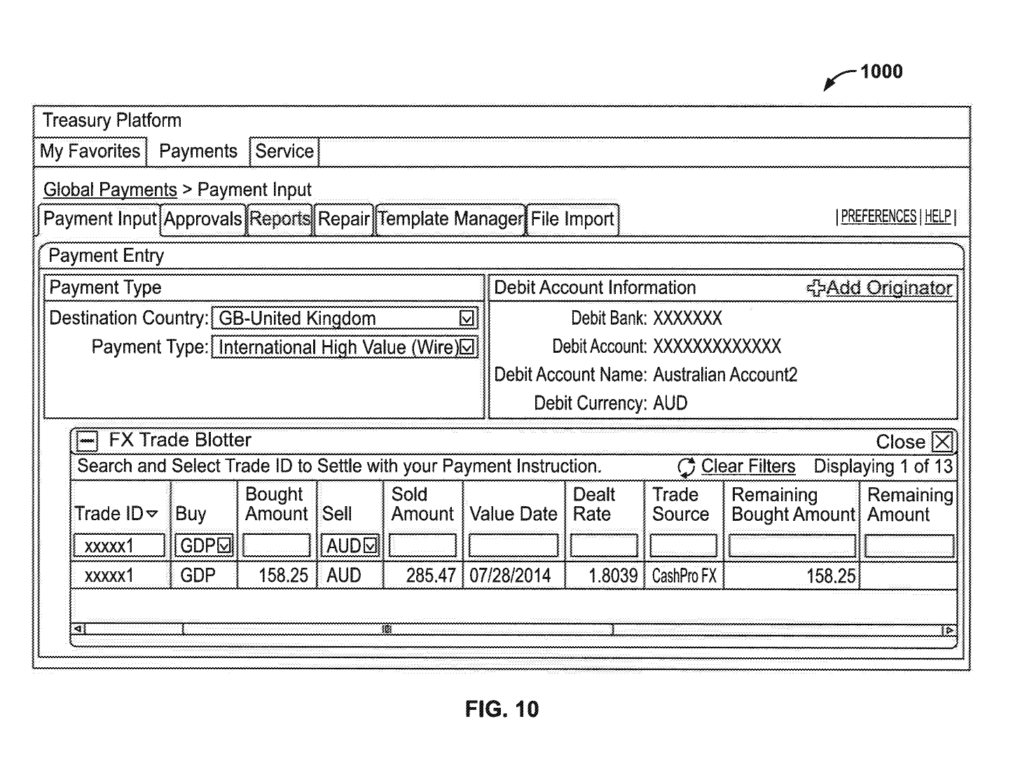

FIG. 10 shows illustrative information 1000. Information 1000 shows how payment entry services provided by treasury platform 300 may be used to settle trades accessible through trading blotter services.

Thus, methods and apparatus for mediating divergent and conflicting workflows of a currency trading platform and a treasury platform have been provided. Persons skilled in the art will appreciate that the present invention can be practiced by other than the described embodiments, which are presented for purposes of illustration rather than of limitation. The present invention is limited only by the claims that follow.

What is claimed is:

1. An interface that performs a computer-implemented method for mediating a difference in timing requirements in a workflow of a trading platform for booking and settling a foreign currency trade, and timing requirements in a workflow of a treasury platform for processing a debit-based payment that utilizes proceeds of the trade, wherein the treasury platform is configured to flexibly schedule and execute debit payments and the trading platform is processes settlement of the foreign currency trade on a value date, the method comprising, within the treasury platform:
receiving the foreign currency trade that converts a first currency into a second currency, the trade associated with proceeds of a total amount A of the second currency;
receiving settlement instructions SI₁ for settling an amount P₁ of the foreign currency trade;
in response to the treasury platform receiving SI₁, communicating with a plurality of other settlement platforms and locking the foreign currency trade from being settled by any of the plurality of other settlement platforms;
preventing execution of the settlement instructions associated with the amount P₁ on the treasury platform, and maintaining an internal database entry showing that the total amount A of the foreign currency trade remains unsettled until, for a plurality of settlement instructions (“SI_{1 . . . n}”) received for the foreign currency trade, each SI_{1 . . . n} being associated with settlement amount P_{1 . . . n}:
Σ₁ⁿP=A; and
funds associated with each settlement amount P_{1 . . . n} has been approved by the treasury platform; and
when Σ₁ⁿP=A, and each settlement amount P_{1 . . . n} has been approved, unlocking the foreign currency trade and allowing execution of SI_{1 . . . n} to settle the total amount A of the foreign currency trade.

2. The interface of claim 1, wherein in the method, when Σ₁ⁿP=A, and each settlement amount P_{1 . . . n} has been approved by the treasury system, the trading system settles the total amount based on the settlement instructions associated with P_{1 . . . n}.

3. The interface of claim 1, wherein in the method, when Σ₁ⁿP=A, and each settlement amount P_{1 . . . n} has been approved by the treasury system, executing the plurality of settlement instructions SI_{1 . . . n} using the treasury platform.

4. The interface of claim 1, wherein in the method, each of P_{1 . . . n} is associated with a distinct method of settlement.

5. The interface of claim 4 wherein the distinct method of settlement is selected from among the group of settlement methods comprising:
a cross currency automated clearing house transfer;
a draft payment;
an account transfer; and
an international wire transfer.

6. The interface of claim 1, wherein in the method, when P₁ is associated with a method of settlement, each of P_{2 . . . n} is settled using the method of settlement associated with P₁.

7. The interface of claim 6, wherein the plurality of other settlement platforms locked out of settling the foreign currency trade include a telephone trading platform.

8. The interface of claim 1, wherein in the method, when the foreign currency trade is past a value date associated with the foreign currency trade, unlocking the foreign currency trade and allowing the plurality of settlement platforms to attach to the foreign currency trade for settlement.

9. The interface of claim 8, wherein in the method, after unlocking the foreign currency trade, each of the plurality of settlement platforms may attach to P_{2 . . . n} and settle any of P_{2 . . . n} without using the settlement method of P₁.

10. An interface that performs a computer-implemented method for controlling access to a foreign currency trade (“trade”) by a currency trading platform that sets a value date for the trade and a treasury platform that schedules a debit-based payment before the value date utilizing proceeds of the trade expected on the value date, the method comprising from within the treasury platform:
booking the trade for converting a first currency into an amount A of the second currency on the value date;
displaying the amount A of the second currency as being available for a debit-based payment;
scheduling a first debit-based payment to allocate the amount A of the second currency to a first payee on a date after the value date associated with the trade;
preventing execution of the first debit-based transaction until the value date;
providing access to settle the trade on or before the value date;
when the trade is settled on or before the value date, executing the first debit-based transaction and transferring the amount A to the first payee; and
when the foreign currency trade remains unsettled on the value date:
assigning a new value date to the trade;
de-allocating the amount A from the first debit-based payment; and
scheduling a second debit-based payment to allocate the amount A of the second currency to a second payee on or after the new value date.

11. The software interface of claim 10, the method comprising showing that the amount A of the second currency remains unsettled until, for a plurality of settlement instructions (“SI_{1 . . . n}”), each SI_{1 . . . n} being associated with a settlement amount SA_{1 . . . n}:
Σ₁ⁿP=A; and
each SI_{1 . . . n} has been verified as being executable by the treasury platform.

12. The interface of claim 11 wherein in the method, when SA₁ is associated with a specific method of settlement, the treasury platform is configured such that each of SA_{2 . . . n} is executed using the specific method of settlement associated with SA₁.

13. The interface of claim 12 wherein the specific method of settlement is selected from among the group of settlement methods comprising:
a cross currency automated clear house transfer;
a draft payment;
an account transfer; and
an international wire transfer.

14. The software interface of claim 10, wherein, the new value date is at least one day before the scheduled execution date of the second debit-based payment.

15. The software interface of claim 10, the method further comprising, after the value date, flagging the trade such that when the trade is accessed via the trading platform the trade is shown as being past the value date.

16. The software interface of claim 11, the method further comprising:
receiving the first settlement amount SA₁ for less than the amount A; and
in response to receiving the first settlement amount SA₁, locking the trade to the treasury platform and preventing the trade from being settled by other platform.

17. An interface that performs a computer-implemented method for mediating a workflow of a trading platform that attempts to access a foreign currency trade and a workflow of a treasury platform that attempts to access the foreign currency trade, the method comprising, from within the treasury platform:
booking, on the trading platform, the foreign currency trade, wherein the foreign currency trade converts a first currency into a second currency based on an exchange rate that yields an amount A of the second currency;
receiving a first payment request (“PR₁”) for a debit-based payment of P₁ of the second currency to a first payee, wherein P₁ is less than A;
receiving a first settlement instruction (“SI₁”) to settle P₁ of the second currency using a first payment method;
displaying (A−P₁) of the second currency as being available for a second payment request (“PR₂”) to a second payee; and
suspending execution of SI₁ until the treasury system:
receives a plurality of settlement instructions SI_{2 . . . n}, each of SI_{2 . . . n} associated with a corresponding settlement amount P_{2 . . . n} such that Σ₂ⁿP=(A−P₁); and
verifying that funds corresponding to each of P_{2 . . . n} are accessible from within the treasury platform; wherein in response to the treasury platform receiving SI₁, the interface is further configured to lock the foreign currency trade from being settled by any other system other than the treasury platform until SI_{1 . . . n} are executed by the treasury platform.

18. The interface of claim 17, wherein the method further comprises receiving a plurality of payment requests (“PR_{2 . . . n}”), each of PR_{2 . . . n} corresponding to a debit-based payment of one of P_{2 . . . n} to one of a plurality of payees; wherein each of P_{2 . . . n} is less than A.

19. The interface of claim 17, wherein, after executing one or more of SI_{1 . . . n-1}:
the foreign currency trade is classified as being unsettled; and
the foreign currency trade is displayed as being partially settled when viewed within a graphical user interface of the interface.

20. The interface of claim 17 wherein when P₁ is associated with a method of settlement, each of P_{2 . . . n} is associated with the method of settlement associated with P₁.
